(19) United States
(12) Patent Application Publication
(10) Pub. No.: US 2022/0398168 A1
(43) Pub. Date: Dec. 15, 2022

(54) AUTO SCALE BACKUP ORCHESTRATION FOR NETWORK ATTACHED STORAGE WORKLOADS

(71) Applicant: EMC IP Holding Company LLC, Hopkinton, MA (US)

(72) Inventors: Upanshu Singhal, Bangalore (IN); Adam Brenner, Mission Viejo (TX); Ashish Kumar, Bangalore (IN); Aaditya Rakesh Bansal, Bangalore (IN); Rintu Kumar Kanp, Bangalore (IN); Soumen Acharya, Bangalore (IN); Chandra Prakash, Bangalore (IN)

(21) Appl. No.: 17/387,190

(22) Filed: Jul. 28, 2021

(30) Foreign Application Priority Data
Jun. 11, 2021 (IN) 202141026051

(51) Int. Cl. G06F 11/14; G06F 9/52

(52) U.S. Cl. CPC G06F 11/1464; G06F 9/52; G06F 2201/84

(57) ABSTRACT

In general, embodiments of the invention relate to a method and system for backing up data. More specifically, embodiments of the invention are directed to using a scalable backup infrastructure that enables portions of the backup process to be performed in parallel. The amount of parallelism that may be implemented in the backup process may be dynamically adjusted based on customer requirements and/or limitations on the computing devices, backup storage, and/or production storage that are used to perform the backup process.

### BACKGROUND

Computing devices generate, use, and store data. The data may be, for example, images, documents, webpages, or meta-data associated with the data. The data may be stored on a persistent storage. In certain scenarios, the data that is stored on the computing device may become unavailable. To ensure that the users can still access their data in such scenarios, a backup of the data may be created. This backup may then be used to restore the data if the data stored on the computing device becomes unavailable.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a system in accordance with one or more embodiments of the invention.

FIGS. 2A-2B show methods performed in a pre-work phase in accordance with one or more embodiments of the invention.

FIGS. 3A-3B show methods performed in a backup phase in accordance with one or more embodiments of the invention.

FIGS. 4A-4B show methods performed in a post-work phase in accordance with one or more embodiments of the invention.

FIG. 5 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure, having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

In general, embodiments of the invention relate to a method and system for backing up data. More specifically, embodiments of the invention are directed to using a scalable backup infrastructure that enables portions of the backup process to be performed in parallel. The amount of parallelism that may be implemented in the backup process may be dynamically adjusted based on customer requirements and/or limitations on the computing devices, backup storage, and/or production storage that are used to perform the backup process.

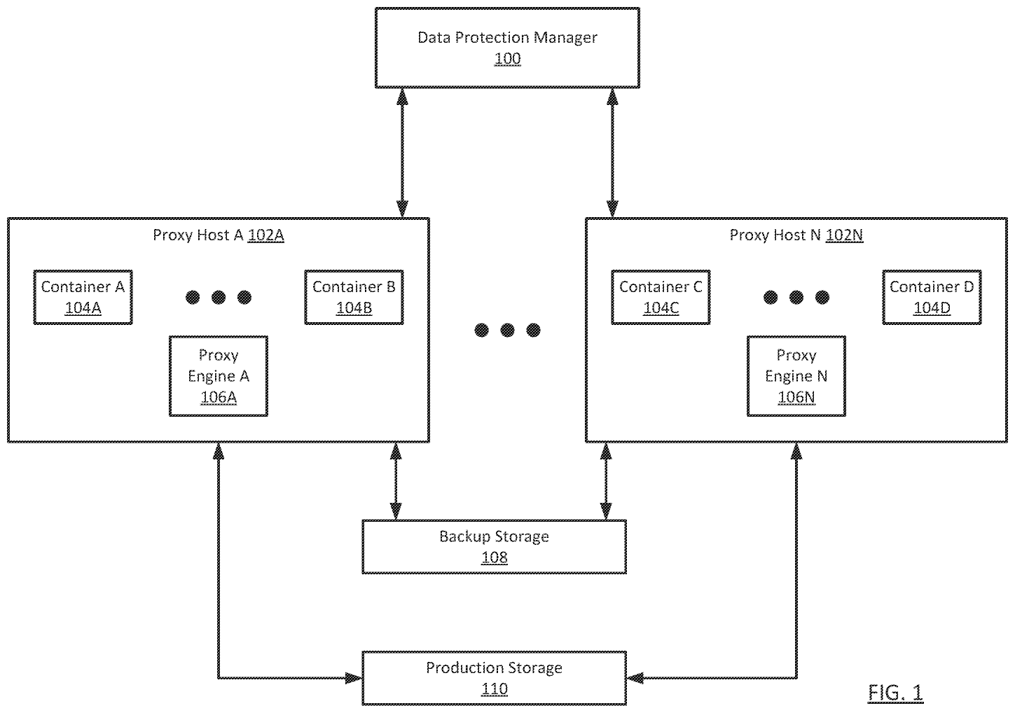

FIG. 1 shows a system in accordance with one or more embodiments of the invention. The system includes a data protection manager (100), one or more proxy hosts (102A, 102N), a backup storage (108) and production storage (110). The system may include additional, fewer, and/or different components without departing from the invention. Each component may be operably connected to any of the other components via any combination of wired and/or wireless connections. Each component illustrated in FIG. 1 is discussed below.

In one embodiment of the invention, the data protection manager (100) includes functionality to manage the overall backup process. Specifically, the data protection manager (100) includes functionality to orchestrate the pre-work phase, the backup phase, and the post-work phase of the backup process. The orchestration includes creating one or more jobs (also referred to as tasks) per phase and then providing proxy hosts sufficient information to execute the one or more jobs. Depending on the phase of the backup process (e.g., the pre-work and post work phases), the jobs are performed serially while, in other phases (e.g., the backup phase), two or more jobs are performed in parallel. While the data protection manager (100) orchestrates the backup process, e.g., orchestrates the servicing of the backup requests, the work required to backup data, that is the subject of the backup request, is primarily done by one or more proxy hosts.

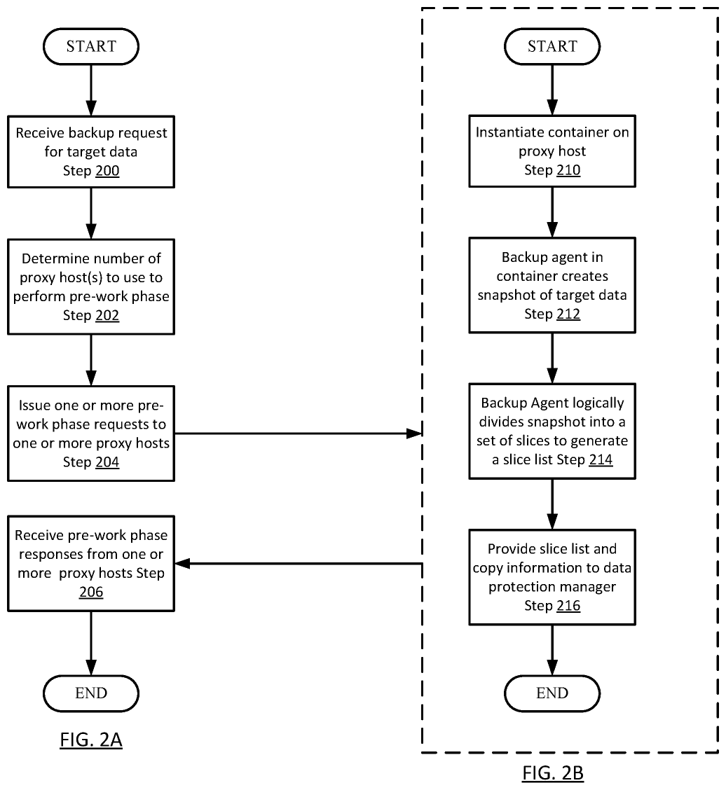

The data protection manager (100) provides the functionality described throughout this application and/or all, or a portion thereof, of the methods illustrated in FIGS. 2A, 3A, and 4A.

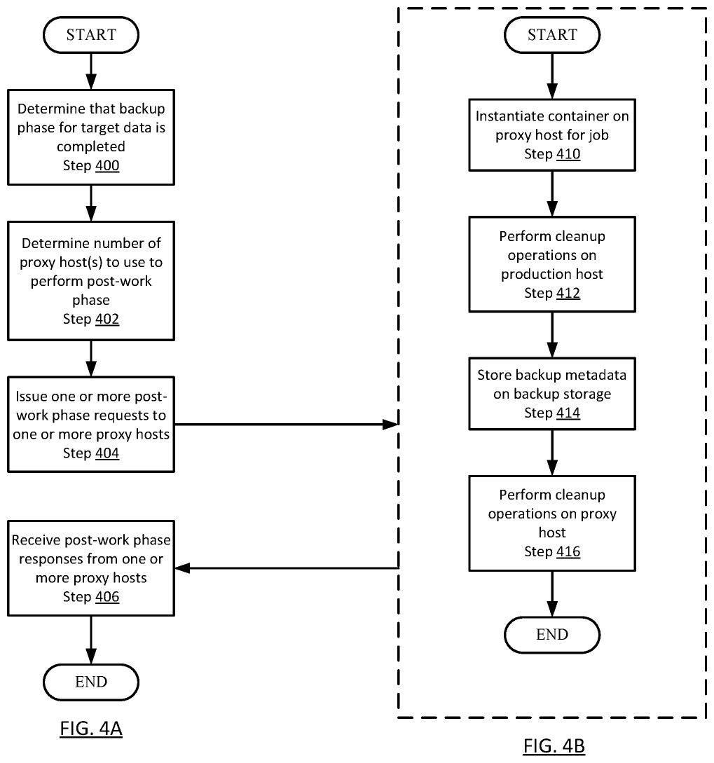

In one or more embodiments of the invention, the data protection manager (100) is implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device, cause the computing device to perform the functionality of the data protection manager (100) described throughout this application.

In one or more embodiments of the invention, the data protection manager (100) is implemented as a logical device. The logical device may utilize the computing resources of any number of computing devices, and thereby provide the functionality of the data protection manager (100) described throughout this application.

In one embodiment of the invention, the proxy host (102A, 102N) includes functionality to interact with the data protection manager (100) to receive jobs, and to provide telemetry information (which may, but is not required to be) in real-time or near real-time. The proxy host (102A, 102N) may include a proxy engine (106A, 106N) to perform the aforementioned functionality. In one embodiment of the invention, the proxy engine (106A, 106N) may communicate with the data protection manager (100) using one or more Representational State Transfer (REST) application programming interfaces (APIs) that are provided by the data protection manager (100).

In one embodiment of the invention, the proxy hosts (102A, 102N) or, more specifically, the proxy engines (106A, 106N), include functionality to: (a) instantiate one or more containers (104A, 104B, 104C, 104D) to execute one or more jobs created by the data protection manager (100), and (b) to shut down and/or remove one or more containers once they have completed processing the job(s).

In one or more embodiments of the invention, a container (104A, 104B, 104C, 104D) is software executing on a proxy host. The container may be an independent software instance that executes within a larger container management software instance (e.g., Docker®, Kubernetes®). In embodiments in which the container is executing as an isolated software instance, the container may establish a semi-isolated virtual environment, inside the container, in which to execute one or more applications.

In one embodiment of the invention, container may be executing in “user space” (e.g., a layer of the software that utilizes low-level system components for the execution of applications) of the operating system of the proxy host.

In one or more embodiments of the invention, the container includes one or more applications. An application is software executing within the container that includes functionality to process the jobs issued by the data protection manager. The functionality may include, but is not limited to, (i) generated snapshots, (ii) logically dividing snapshots into slices, (iii) reading data from snapshots on the production host (110) and (iv) writing the data to backup storage (108). The aforementioned functionality may be performed by a single application or multiple applications.

The proxy hosts (102A, 102N) provide the functionality described throughout this application and/or all, or a portion thereof, of the methods illustrated in FIGS. 2B, 3B, and 4B.

In one or more embodiments of the invention, the proxy hosts (102A, 102N) are implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device, cause the computing device to perform the functionality of the proxy hosts (102A, 102N) described throughout this application.

In one or more embodiments of the invention, proxy hosts (102A, 102N) are implemented as a logical device. The logical device may utilize the computing resources of any number of computing devices, and thereby provide the functionality of the proxy hosts (102A, 102N) described throughout this application.

In one embodiment of the invention, the backup storage (108) includes any combination of volatile and non-volatile storage (e.g., persistent storage) that stores data that stores backup copies of the data that was (and may still be) in the production storage. The backup storage may store data in any known or later discovered format.

In one embodiment of the invention, the production storage (110) includes any combination of volatile and non-volatile storage (e.g., persistent storage) that stores data that is being actively used by one or more production systems (not shown). The production storage (110) may be referred to as network attached storage (NAS) and may be implemented using any known or later discovered protocols that are used to read from and write data to NAS.

While the system of FIG. 1 has been illustrated and described as including a limited number of specific components, a system in accordance with embodiments of the invention may include additional, fewer, and/or different components without departing from the invention

FIGS. 2A- 2B show methods performed in a pre-work phase in accordance with one or more embodiments of the invention. The method shown in FIG. 2A may be performed by, for example, a data protection manager. Other components of the system in FIG. 1 may perform all, or a portion, of the method of FIG. 2A without departing from the invention. The method shown in FIG. 2B may be performed by, for example, a proxy host. Other components of the system in FIG. 1 may perform all, or a portion, of the method of FIG. 2B without departing from the invention

While FIGS. 2A-2B are illustrated as a series of steps, any of the steps may be omitted, performed in a different order, additional steps may be included, and/or any or all of the steps may be performed in a parallel and/or partially overlapping manner without departing from the invention.

Turning to FIG. 2A, in step 200, a backup request is received by the data protection manager. The backup request may be generated by a process executing on the data protection manager (e.g., in scenarios in which the backup request is part of a scheduled backup) or from an external source. The backup request may specify target data (which may also be referred to as a share), which is the data that is located on the production storage that is to be backed up. The backup request may also specify whether the backup is to be a full backup or an incremental backup. The backup request may identify single or multiple shares. In the scenarios in which there are multiple shares, the backup request may specify the aforementioned information for each share.

In step 202, one or more proxy hosts are identified to perform the pre-work phase to service the backup request. The pre-work phase for a given share is performed by a single container. However, as a given proxy host may support multiple containers, if there are multiple shares to be backed-up, there may be one container allocated per share. The data protection manager, using telemetry data on the current workload of each of the proxy hosts, determines the number of required containers and which proxy host(s) are to be used to instantiate these containers to perform the pre-work phase.

In step 204, the data protection manager may issue requests to one or more proxy hosts (as determined in step 202) to instantiate the container(s) to perform the pre-work phase of the backup process.

Steps 210-216, FIG. 2B, describe the pre-work phase that is performed by the proxy hosts in accordance with one or more embodiments of the invention. Steps 210-216 may be performed for each container that needs to be instantiated in order to service the backup request. Accordingly, if the backup request only specifies one share, then only one container is instantiated; however, if the backup request specifies N shares, then N containers need to be instantiated. In the latter scenario, each of the N containers may be executing in parallel.

Turning to FIG. 2B, in step 210, a proxy host receives the request to instantiate a container from the data protection manager and then instantiates the container.

In step 212, a backup agent (i.e., an application) executing in the container creates a snapshot of the target data (i.e., a snapshot of the share). Creating the snapshot includes instructing the production host that is interacting with the share to quiese writes to the share and, once all writes to the share have been quiesed, a snapshot of the share is generated and stored in a production storage. Once the snapshot has been taken access to the share, the production host may resume issuing writes to the share. The result of step 212 includes the backup agent obtaining the path (i.e., the location) of the snapshot on the production storage.

In step 214, the backup agent (or another agent executing on the container), analyzes the data in the snapshot to determine its file structure (e.g., the directory and file structure), and corresponding sizes of the items in the file structure. Based on this information, the backup agent (or another agent executing on the container) logically divides the snapshot into slices. For example, snapshot may be divided into 200 GB slices. Each slice includes a non-overlapping portion of the snapshot and does not include any partial files (i.e., each file is only located in one slice). The size of the slices may be the same or substantially similar; however, they are not required to be the same or substantially similar The result of this process is a slice list.

The aforementioned discussion of the slice list generation is for full backups; however, in scenario in which the backup request specifies an incremental backup, the backup agent (or another agent executing on the container) may obtain the slice list from the backup storage that is associated with the last backup (which may be a full backup or synthetic backup). The backup agent (or another agent executing on the container) analyzes the data in the snapshot to determine what data in the snapshot has changed since the last backup, and then generates a list of slices where at least a portion of each of the slices includes data that has been added or modified since the last backup. In this scenario, the slice list may be substantially smaller as compared to a slice list that is generated for a full backup. The result of this process is a slice list, albeit a slice list with different contents than a slice list that would have been generated for a full backup.

In step 216, the backup agent (or another agent executing on the container) (directly or via the proxy engine), sends the slice list and copy information to the data protection manager. The slice list identifies the slices, while the copy information specifies the location of each of the slices as well as other metadata associated with the slices. The copy information may specify any other information required to perform the subsequent phases of the backup process. Once the data has been transmitted, the container that was used to perform the aforementioned steps may be removed from the proxy host.

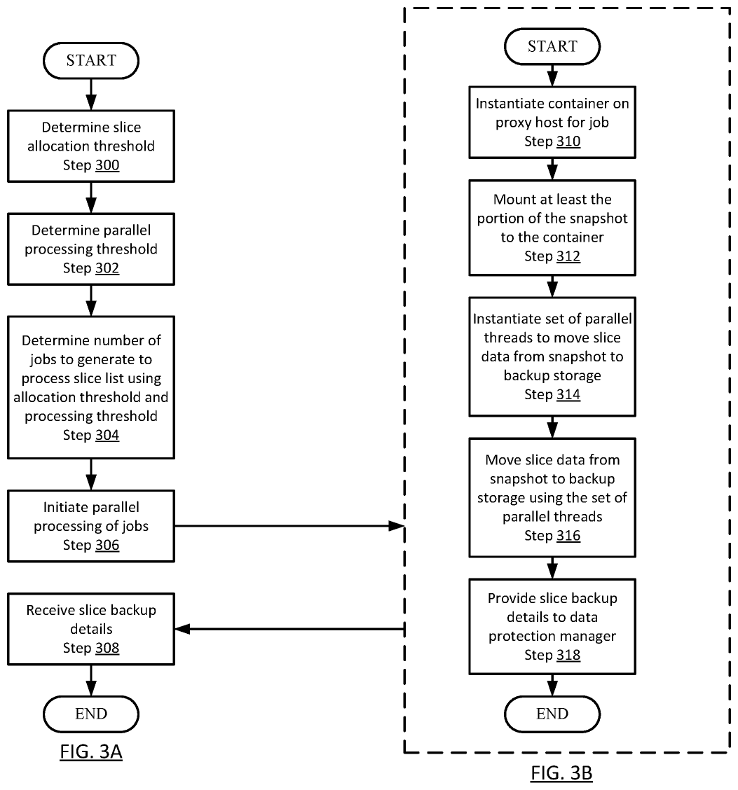

Returning to FIG. 2A, in step 206, the data protection manager receives the pre-work phase responses (e.g., the slice list and the copy information) from the proxy host(s). Once the data protection manager receives this information for a given share, the pre-work phase for that share is complete and the data protection manager may start performing the backup phase of the backup process (see e.g., FIG. 3A).

FIGS. 3A-3B show methods performed in a backup phase in accordance with one or more embodiments of the invention. The method shown in FIG. 3A may be performed by, for example, a data protection manager. Other components of the system in FIG. 1 may perform all, or a portion, of the method of FIG. 3A without departing from the invention. The method shown in FIG. 3B may be performed by, for example, a proxy host. Other components of the system in FIG. 1 may perform all, or a portion, of the method of FIG. 3B without departing from the invention

While FIGS. 3A-3B are illustrated as a series of steps, any of the steps may be omitted, performed in a different order, additional steps may be included, and/or any or all of the steps may be performed in a parallel and/or partially overlapping manner without departing from the invention.

Turning to FIG. 3A, in step 300, the data protection manager determines, if one is set, a slice allocation threshold. The slice allocation threshold corresponds to a maximum number of slices that may be assigned to a container during the backup phase. The slice allocation threshold may be set to a default value, e.g., no more than 16 slices per container; may be set based on a user policy, may not be specified (i.e., there is no slice allocation threshold); and/or may be set using any other mechanism. The slice allocation threshold may be specified for all backup requests, may be specified on a per user (tenant basis), may be specified using any other level of granularity. The slice allocation threshold may be specified as part of the configuration of the data protection manager and/or as within the backup request.

In step 302, the data protection manager determines, if one is set, a parallel processing threshold. The parallel processing threshold corresponds to the maximum number of threads across all containers that may be concurrently read data from the share. The parallel processing threshold may be set to a default value, e.g., no more than 20 threads may concurrently access the data on the share; may be set based on a user policy, may not be specified (i.e., there is no parallel processing threshold); and/or may be set using any other mechanism. The parallel processing threshold may be specified for all backup requests, may be specified on a per user (tenant basis), may be specified using any other level of granularity. The parallel processing threshold may be specified are part of the configuration of the data protection manager and/or as within the backup request.

In step 304, the data protection manager divides the slice list to generate a set of jobs, where each of the jobs includes a portion of the slice list. Each job is processed by its own container and each container may instantiate its own set of threads to execute the job in parallel. The division of the slice list may take into account the slice allocation threshold (if available), the parallel processing threshold (if available), and any other information (e.g., telemetry information) or policies to divide the slice list. The result of step 304 is a set of jobs, where each job specifies the slices and the number of threads to instantiate in each of the containers.

The following is a non-limiting example of generating a set of jobs. Turning to the example, consider a scenario in which there are 48 slices (labeled 1-48), the slice allocation threshold is 8 and the parallel processing threshold is 20. Based on this the following jobs may be created.

| Job No. | Allocated Slices | Concurrent Threads |
|---|---|---|
| 1 | 1-8 | 8 |
| 2 | 9-16 | 8 |
| 3 | 17-24 | 4 |
| 4 | 25-32 | 8 |
| 5 | 33-40 | 8 |
| 6 | 41-48 | 4 |

The aforementioned scenario assumes that the jobs will be processed in ascending order (i.e., from 1-6) and that at no point in time will jobs any three of the jobs 1, 2, 4, and 5 be executing concurrently. However, in another embodiment of the invention the invention, the data protection manager may organize the queue (and/or update the ordering of the queue) to enforce the parallel processing threshold.

In step 306, the data manager initiates the parallel processing of the jobs generated in step 304. In one embodiment of the invention, the data protection manager places the jobs in a queue and then the proxy hosts select jobs to process from the queue. In this scenario, the data protection manager does not track the workload (or, more generally, does not track the state) of the various proxy hosts; rather, the proxy engine of the proxy host determines the available resource on the proxy host, and then request a number of jobs equal to the number of container that it has the resources to instantiate.

In one embodiment of the invention, the data protection manager places the jobs in a queue and then allocates the jobs to the proxy hosts. In this scenario, the data protection manager tracks the workload of the various proxy hosts, determines the available resource on each of the proxy hosts using the aforementioned information, and then allocates a number of jobs equal to the number of container that a given proxy host has the resources to instantiate.

Steps 310-318, FIG. 3B, describe the backup phase that is performed by the proxy hosts in accordance with one or more embodiments of the invention. Steps 310-318 may be performed for each job that is to be processed by a proxy host. Each of the containers that are instantiate as part of the processing of the jobs in backup phase for a given share may be executed in parallel on the same and/or different proxy hosts.

Turning to FIG. 3B, in step 310, a proxy host receives the request to instantiate a container to process a job from the data protection manager and then instantiates the container. The instantiation of the container may include configuring the container to not instantiate more than a certain number of parallel threads (see above example). The request from the proxy host for the job includes all the necessary information to configure the container to process the job.

In step 312, a backup agent (i.e., an application) executing in the container, mounts at least a portion of the share associated with the slices associated with the job that the container is processing.

In step 314, the container instantiates a set of parallel threads (which may be up to a configured limit) The threads may execute processes to establish individual connections (e.g., transmission control protocol sessions) with the backup storage and/or the production storage to (i) read data for at least a portion of a slice associated with the job, and (ii) store the data that was read in an appropriate location in the backup storage. Depending on the implementation, there may be threads only tasked with reading data from the production storage, and other threads only tasked with writing data to the backup storage.

In step 316, the threads instantiated in step 314 read data from the production storage and write data to the backup storage. The threads process all slices that are associated with the job and, as a result, copy data associated with these slices to the backup storage.

In step 318, once all of the data for the slices associated with the job has been stored in the backup storage, the slice backup details are gathered and provided to the data protection manager. The slice backup details includes metadata that specifies which of the data from the slices associated with the job is stored in the backup storage.

Returning to FIG. 3A, in step 308, the data protection manager receives the backup slice details.

In one embodiment of the invention, all jobs determined in step 304 may be performed in parallel using containers on the same or different proxy hosts. In another embodiment of the invention, a portion of the jobs may be performed in parallel on a set of containers on the same or different proxy hosts, and then another portion of the jobs may be performed on the same set of container after the initial set is completed. This process may continue until all jobs generated in step 304 are processed.

The following is an example to illustrate the latter embodiment. Consider the scenario shown above in which there were six jobs created. Further, assume that only two containers can be instantiated at any one time (e.g., due to limited computing resources available on the proxy hosts). In this scenario, Job 1 is performed on Container 1 and Job 2 is performed on Container 2. Job 1 is completed first (and Container 1 is subsequently removed) and, as such, Job 3 is initiated on new Container 3. Once Job 2 is completed (and Container 2 is removed), Job 4 is initiated on new Container 4. Job 4 is completed before Job 3 (and Container 4 is removed) and, as such, Job 5 is initiated on new Container 5.

Once Job 3 completes (and Container 3 is removed), Job 6 is initiated on new Container 6.

FIGS. 4A-4B show methods performed in a post-work phase in accordance with one or more embodiments of the invention. The method shown in FIG. 4A may be performed by, for example, a data protection manager. Other components of the system in FIG. 1 may perform all, or a portion, of the method of FIG. 4A without departing from the invention. The method shown in FIG. 4B may be performed by, for example, a proxy host. Other components of the system in FIG. 1 may perform all, or a portion, of the method of FIG. 4B without departing from the invention

While FIGS. 4A-4B are illustrated as a series of steps, any of the steps may be omitted, performed in a different order, additional steps may be included, and/or any or all of the steps may be performed in a parallel and/or partially overlapping manner without departing from the invention.

Turning to FIG. 4A, in step 400, a determination is made that the backup phase for target data is completed. When all jobs are completed (e.g., all jobs generated in Step 304), the data protection manager determines that the backup phase is complete.

In step 402, one or more proxy hosts are identified to perform the post-work phase to service the backup request. The post-work phase for a given share is performed by a single container. If there are multiple shares for which to perform post-work, then there may be one container allocated per share. The data protection manager, using telemetry data on the current workload of each of the proxy hosts, determines the number of required containers and which proxy host(s) are to be used to instantiate these containers to perform the pre-work phase.

In step 404, the data protection manager may issue requests to one or more proxy hosts (as determined in step 402) to instantiate the container(s) to perform the post-work phase of the backup process.

Steps 410-416, FIG. 4B, describe the post-work phase that is performed by the proxy hosts in accordance with one or more embodiments of the invention. Steps 410-416 may be performed for each container that needs to be instantiated in order to service the backup request. Accordingly, if the backup request only specifies one share, then only one container is instantiated; however, if the backup request specifies N shares, then N containers need to be instantiated. In the latter scenario, each of the N containers may be executing in parallel.

Turning to FIG. 4B, in step 410, a proxy host receives the request to instantiate a container from the data protection manager and then instantiate the container.

In step 412, a backup agent (or another application executing in the container) performs cleanup operations on the production host including, e.g., deleting the snapshot from the production host.

In step 414, the backup agent (or another application executing in the container) obtains all of the slice backup details for the share (i.e., all of the slice backup details generated by performing each of the jobs) from the data protection manager and stores this data as backup metadata in the appropriate location in the backup storage.

In step 416, the backup agent (or another application executing in the container) performs any other required cleanup operations on the proxy host(s) that were used to process the jobs. The backup agent (or another application executing in the container) then notifies the data protection manager that the post-work phase is complete.

Returning to FIG. 4A, in step 406, the data protection manager receives the post-work phase responses (e.g., notifications issued in Step 416) from the proxy host(s). Once the data protection manager receives this information for a given share, the post-work phase for that share is complete and the data protection manager may deem the servicing of the backup request to be completed. The data protection manager may then send a response back to the entity that issued the backup request indicating that the servicing of the backup request is completed.

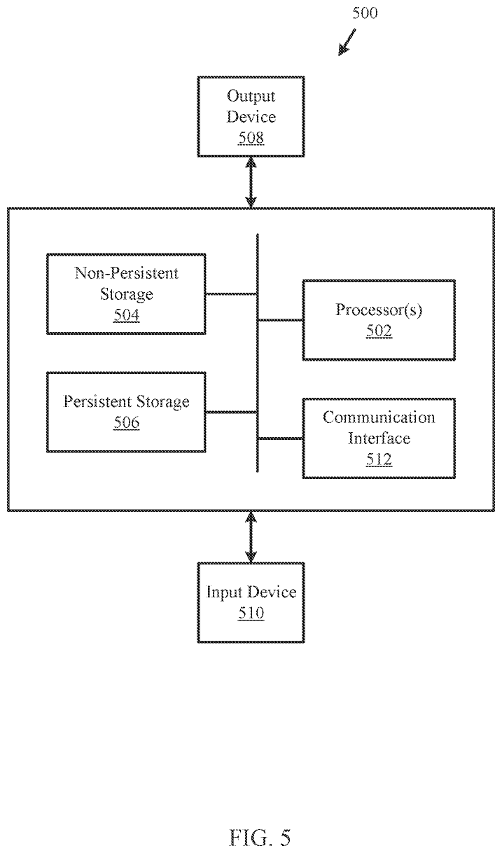

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

The problems discussed above should be understood as being examples of problems solved by embodiments of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention. Accordingly, the scope of the invention should be limited only by the attached claims.

What is claimed is:

1. A method for backing up data, the method comprising:
initiating performance of a pre-work phase on a proxy host of a plurality of proxy hosts to obtain a set of slices and copy information, wherein the pre-work phase is associated with a backup request for target data on production storage;
determining a number of jobs to generate to service the backup request based on at least one of a slice allocation threshold and a parallel processing threshold;
generating a set of jobs based on the numbers of jobs, wherein each job in the set of jobs is associated with at least one slice of the set of slices;
initiating performance of the set of jobs on at least one of a plurality of proxy hosts;
determining that performance of the set of jobs has been completed; and
initiating performance of a post-work phase on a second proxy host of the plurality of proxy hosts, wherein servicing of the backup request is complete when the post-work phase is completed.

2. The method of claim 1, wherein initiating performance of the pre-work phase on the proxy host comprises:
instantiating a container on the proxy host, wherein the container comprises a backup agent, which when executing in the container, generates a snapshot of the target data and logically divided the snapshot in the set of slices.

3. The method of claim 2, wherein the container is removed from the proxy host after the pre-work phase is completed.

4. The method of claim 1, wherein initiating performance of the set of jobs on the at least one of a plurality of proxy hosts comprises:
instantiating a container for a job in the set of jobs;
performing, by the container, the job, wherein performing the job comprises reading data associated with a slice of the set of slices from the production storage and writing the data associated with the slice to backup storage;
instantiating a second container for a second job in the set of jobs;
performing, by the second container, the second job, wherein performing the second job comprises reading second data associated with a second slice of the set of slices from the production storage and writing the second data associated with the second slice to backup storage.

5. The method of claim 4, wherein the job and the second job are performed in parallel by the container and the second container.

6. The method of claim 4, wherein the container performs the job using a plurality of threads, wherein the plurality of threads execute in parallel.

7. The method of claim 1, wherein the proxy host is a physical computing device or a logical computing device.

8. The method of claim 1, wherein the production storage is network attached storage that is used by a production system.

9. The method of claim 1, wherein the proxy host and the second proxy host is the same proxy host.

10. The method of claim 1, wherein the slice allocation threshold specifies a maximum number of slices that may be assigned to a container.

11. The method of claim 1, wherein the parallel processing threshold specifies a maximum number of concurrently executing threads that may be processing jobs associated with the target data.

12. A system, comprising:
a data protection manager;
a proxy host and a second proxy host;
backup storage;
production storage;
wherein the data protection manager, the proxy host, the second proxy host, the backup storage and the production storage are operatively connected;
wherein the data protection manager is configured to:
initiate performance of a pre-work phase on the proxy host obtain a set of slices and copy information, wherein the pre-work phase is associated with a backup request for target data on the production storage;
determine a number of jobs to generate to service the backup request based on at least one of a slice allocation threshold and a parallel processing threshold;
generate a set of jobs based on the number of jobs, wherein each job in the set of jobs is associated with at least one slice of the set of slices;
initiate performance of the set of jobs on the proxy host and the second proxy host;
determine that performance of the set of jobs has been completed; and
initiate performance of a post-work phase on the second proxy host, wherein servicing of the backup request is complete when the post-work phase is completed.

13. The system of claim 12, wherein initiating performance of the pre-work phase on the proxy host comprises:
instantiating a container on the proxy host, wherein the container comprises a backup agent, which when executing in the container, generates a snapshot of the target data and logically divided the snapshot in the set of slices.

14. The system of claim 13, wherein the container is removed from the proxy host after the pre-work phase is completed.

15. The system of claim 12, wherein initiating performance of the set of jobs on the proxy host and the second proxy host:
instantiating a container on the proxy host for a job in the set of jobs;
performing, by the container, the job, wherein performing the job comprises reading data associated with a slice of the set of slices from the production storage, and writing the data associated with the slice to the backup storage;
instantiating a second container on a second proxy host for a second job in the set of jobs;
performing, by the second container, the second job, wherein performing the second job comprises reading second data associated with a second slice of the set of slices from the production storage and writing the second data associated with the second slice to the backup storage.

16. The system of claim 15, wherein the job and the second job are performed in parallel by the container and the second container.

17. The system of claim 15, wherein the container performs the job using a plurality of treads, wherein the plurality of threads execute in parallel.

18. The system of claim 12, wherein the proxy host is a physical computing device or a logical computing device.

19. The system of claim 12, wherein the production storage is network attached storage that is used by a production system.

20. The system of claim 12,
wherein the slice allocation threshold specifies a maximum number of slices that may be assigned to a container, and
wherein the parallel processing threshold specifies a maximum number of concurrently executing threads that may be processing jobs associated with the target data.
